(19) United States
(12) Patent Application Publication
(10) Pub. No.: US 2018/0123385 A1
(43) Pub. Date: May 3, 2018

(54) HARDWARE SWITCH INITIATED BATTERY CURRENT CONTROL

(71) Applicant: QUALCOMM Incorporated, San Diego, CA (US)

(72) Inventors: Hiroshi AKIYAMA, San Diego, CA (US); Eric MIKUTEIT, San Diego, CA (US); Hardik PATEL, San Diego, CA (US); Todd SUTTON, Del Mar, CA (US)

(21) Appl. No.: 15/583,654

(22) Filed: May 1, 2017

Related U.S. Application Data
(60) Provisional application No. 62/414,551, filed on Oct. 28, 2016.
(60) Provisional application No. 62/464,318, filed on Feb. 27, 2017.

(51) Int. Cl. H02J 9/04; H02J 9/00; H04B 1/3827; H04B 1/3883

(52) U.S. Cl. CPC H02J 9/04; H04B 1/3883; H04B 1/3833; H02J 9/005

(57) ABSTRACT

A method of enabling a battery hot swap in a mobile device includes detecting when a removable first battery will be removed. The removable first battery may power the mobile device. The method includes reducing a system current to a predetermined level in response to the detecting. The method may further include sourcing current from a second battery when the removable first battery is removed.

### CROSS-REFERENCE TO RELATED APPLICATIONS

The present application claims the benefit of U.S. Provisional Patent Application No. 62/414,551, filed on Oct. 28, 2016, and titled “HARDWARE SWITCH INITIATED BATTERY CURRENT CONTROL,” and U.S. Provisional Patent Application No. 62/464,318, filed on Feb. 27, 2017, and titled “HARDWARE SWITCH INITIATED BATTERY CURRENT CONTROL,” the disclosures of which are expressly incorporated by reference herein in their entireties.

### BACKGROUND

### Field

The present disclosure generally relates to power management systems. More specifically, aspects of the present disclosure relate to hardware switch initiated battery current control for hot swapping a battery.

### Background

Many modern electronic systems (e.g., wireless devices) rely on one or more batteries for power. The batteries are typically recharged, for example, by connecting the electronic system to a power source (e.g., an alternating current (AC) power outlet) via a power adapter and cable.

In some dual battery phones, a secondary battery is smaller than a primary battery. Swapping the primary battery while a high level operating system (HLOS) of the device is still running may interrupt operation of the device. For example, if the primary battery is removed while there is a high current load, the smaller secondary battery will instantly need to source the higher load current. This may be problematic when the smaller secondary battery has a lower current limit than the primary battery, and therefore is unable to source the higher current load.

### SUMMARY

In an aspect of the present disclosure, a method of enabling a battery hot swap in a mobile device includes detecting when a removable first battery will be removed. The removable first battery may power the mobile device. The method may include reducing a system current to a predetermined level in response to detecting when the removable first battery will be removed. The method may further include sourcing current from a second battery when the removable first battery is removed.

In another aspect of the present disclosure, a battery hot swap circuit includes a removable first battery configured to power a mobile device. The battery hot swap circuit may further include a power control switch coupled to the removable first battery. The power control switch may be configured to reduce a system current to a predetermined level in response to an indication that the removable first battery will be removed. A power management circuit may be coupled to the power control switch. The battery swap circuit may further include a second battery coupled to the power control switch. The second battery may be configured to power the mobile device at the predetermined level when the removable first battery is removed.

In yet another aspect of the present disclosure, a battery hot swap circuit includes means for detecting when a removable first battery will be removed. The removable first battery may power a mobile device. The battery hot swap circuit may further include means for reducing a system current to a predetermined level in response to a signal from the means for detecting. The battery hot swap circuit may further include means for sourcing current from a second battery when the removable first battery is removed.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 depicts a simplified system for delivering power in an electronic device according to one aspect of the present disclosure.

FIG. 2 depicts a more detailed example of the system according to one aspect of the present disclosure.

FIG. 3 illustrates an exemplary implementation for a dual battery system without a hardware switch according to aspects of the present disclosure.

FIG. 4 illustrates an exemplary implementation for a dual battery system with a hardware switch for initiating battery current mitigation according to aspects of the present disclosure.

FIG. 5 depicts a simplified flowchart of a method of enabling a battery swap using hardware switching to initiate battery current mitigation according to one aspect of the present disclosure.

FIG. 6 is a block diagram showing an exemplary wireless communication system in which an aspect of the present disclosure may be advantageously employed.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. The term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches.

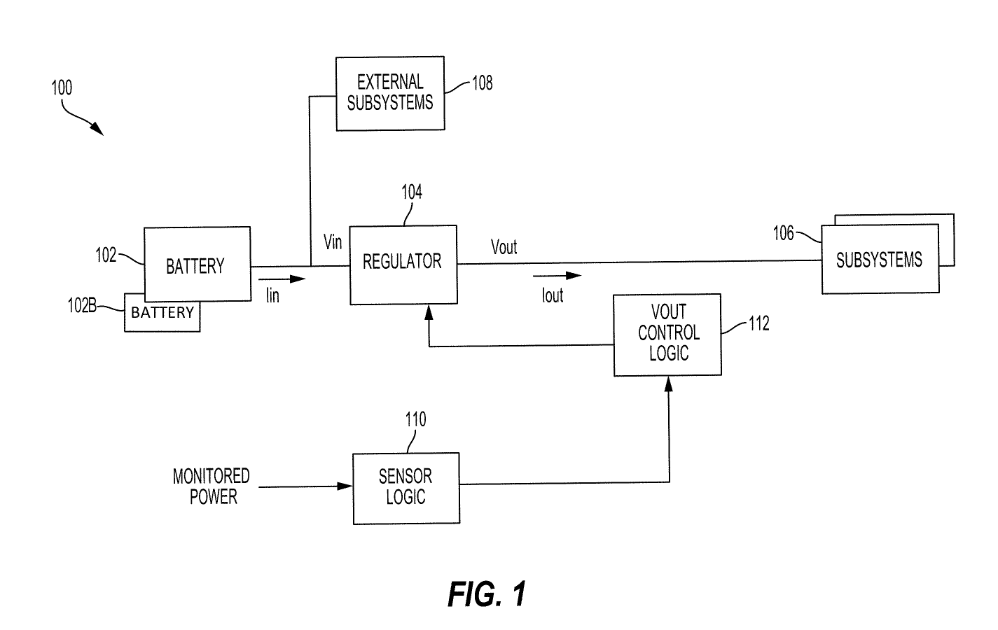

FIG. 1 depicts a system 100 for delivering power in an electronic device according to one aspect of the present disclosure. The system 100 includes a primary battery 102 that may provide a power supply voltage from outside a chip including a voltage regulator (e.g., regulator 104). The regulator 104 may deliver a power supply voltage (e.g., a voltage rail) from the battery 102 to different subsystems 106. In addition, external subsystems 108 may be located external to the chip that includes the regulator 104. The external subsystems 108 may not draw power from the regulator 104, but may still draw power from the battery 102. A secondary battery 102B may also be provided to provide power when swapping out the primary battery 102.

The system 100 may be part of an electronic device, such as a cellular phone, tablet, or other mobile device. In one aspect, the regulator 104 is highly integrated in the electronic device with the subsystems 106 and the external subsystems 108. The regulator 104 may be a buck regulator, a boost regulator, and/or a buck-boost regulator. The regulator 104 regulates the output voltage Vout from the regulator 104 to different subsystems 106. For example, in boost mode, the regulator 104 may increase the level of an input voltage Vin that is received from the battery 102. In addition, in buck mode, the regulator 104 may decrease the level of the input voltage Vin that is received from the battery 102.

The system 100 includes subsystems 106 (e.g., loads) that draw power from the regulator 104. These subsystems 106 may include different minimum power supply voltage specifications. For example, the minimum operating voltage may be a level below which the subsystems may no longer operate properly. The subsystems 106 may draw different levels of power (e.g., current and/or voltage) at different times depending on the operations the subsystems are performing. Further, different subsystems may draw power at different times. For instance, a subsystem may draw power when actively performing an operation, but not draw a lot of power when idle. In one example, an electric flash on a camera may draw a large current for a short time when the flash is operated, a Wi-Fi or cellular subsystem may draw a large current during transmission, or a computer processor may draw a large current while processing a large instruction block.

In a highly-integrated system, such as a mobile phone or tablet computer, the power delivery capability of the regulator 104 may be limited by the power available from the battery 102. Under certain conditions, the regulator 104 may not be able to provide sufficient power to meet all the demands of the subsystems 106. When the power specified for multiple subsystems increases past the available power, the power supply voltage at the output of the regulator 104 may drop, causing one or more subsystems 106 to fail.

Sensor logic 110 and Vout control logic 112 may be provided to adjust the output voltage Vout such that the regulator 104 is able to provide sufficient power to subsystems 106. In one aspect, sensor logic 110 and Vout control logic 112 may be part of the regulator 104. The sensor logic 110 monitors power in the electronic device and uses multiple thresholds to determine when to increase or decrease the output voltage Vout of the regulator 104. The thresholds may be set below an absolute limit threshold in which the electronic device may not operate properly if the absolute limit is met. Vout control logic 112 controls the output voltage Vout by increasing or decreasing the output voltage in increments. The output voltage Vout may only be decreased to the minimum voltage level or increased to a maximum voltage level. These levels are based on voltage levels requested from a set of subsystems and priority levels associated with those subsystems.

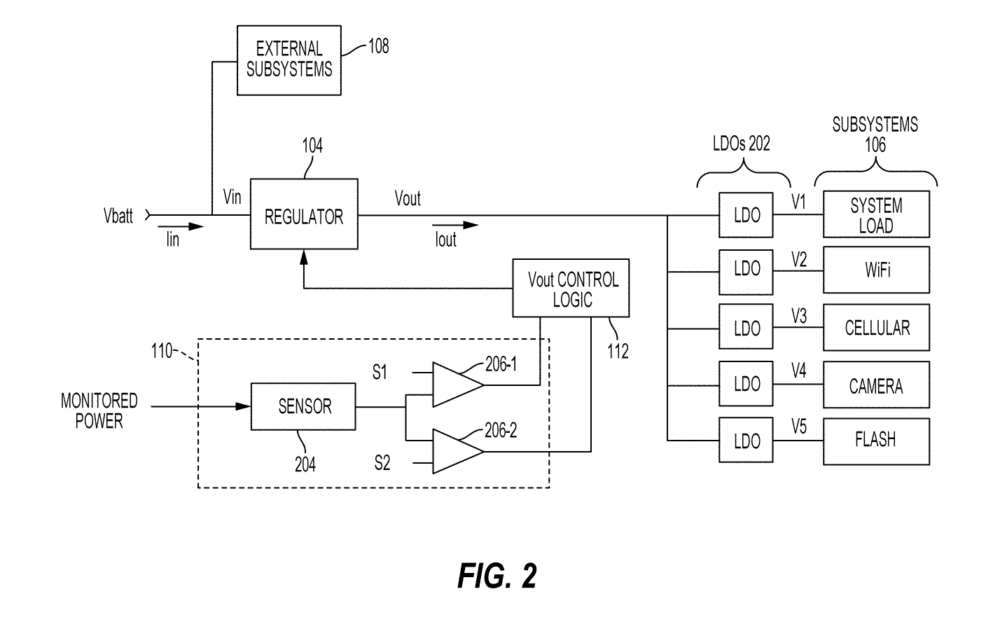

FIG. 2 depicts a more detailed example of the system 100. In this example, an implementation of the sensor logic 110 is shown, but it will be recognized that other implementations are possible. For example, the sensor logic 110 may be implemented in analog circuits, digital circuits, and/or software.

The regulator 104 receives a battery voltage Vbatt (or current Iin) from the battery (e.g., battery 102 shown in FIG. 1), and provides an output voltage Vout (or current Tout) to low drop-out (LDO) regulators 202. The LDO regulators 202 customize the internal power supply voltage to each of the subsystems 106. For example, a system load may specify a voltage V1, a Wi-Fi subsystem may specify a voltage V2, a cellular subsystem may specify a voltage V3, a camera subsystem may specify a voltage V4, and a flash subsystem may specify a voltage V5. These voltages may be the minimum voltage specified for the subsystems to operate properly. For example, if the output voltage drops below this level, a subsystem may experience decreased performance. However, in some cases, the subsystem may not experience a total failure.

Each of these subsystems may be assigned a priority from multiple different priorities. For example, a first higher priority is defined as a “priority level 1” and a second lower priority is defined as a “priority level 0”. The minimum and maximum output voltage (Vout) levels of the regulator 104 are generated based on the priorities and the power supply voltages being requested by the subsystems 106. For example, a minimum allowable Vout level may be defined by the requested power supply voltages of the subsystems 106 designated as “priority level 1.”

In one example, the Wi-Fi subsystem may specify 3.6 V to operate properly, but others of the subsystems 106, such as the system load, may specify only 3.3 V. Wi-Fi may be designated as a low priority load and assigned the priority level 0 and the system load is designated as a high priority level 1. In this case, during high power loading, it may be acceptable to reduce the power supply output voltage Vout to be lower than 3.6 V (the level requested by Wi-Fi), but not less than 3.3 V (the level requested by the system load). This reduced voltage may reduce the performance of the Wi-Fi subsystem, but the user impact might be minimal. That is, as long as the power supply voltage is above 3.3 V, the priority level 1 subsystems 106 may operate properly, but the Wi-Fi subsystem may possibly operate with a reduced performance. Wi-Fi is considered a lower priority and the reduced performance is tolerated and may not noticeably impact a user of the electronic device. At the expense of reduced performance of the Wi-Fi subsystem, a shutdown of any subsystem or the entire electronic device may be avoided.

Sensor logic 110 includes a sensor 204 that monitors the power from one or more locations in the electronic device. The locations may be at the input of the regulator 104, the output of the regulator 104, within the regulator 104, the output of the battery 102, and the input of external subsystems 108. In one aspect, the sensor 204 monitors the input current through the regulator 104, such as through an inductor of the regulator 104. In other examples, either the current or the voltage output by the battery 102 or input to external subsystems 108 may be monitored.

Comparison logic shown as a first comparator 206-1 and a second comparator 206-2 receives the monitored power and can compare the monitored power to different thresholds. For example, the first comparator 206-1 compares the power to a first threshold S1 and the second comparator 206-2 compares the power to a second threshold S2. The first threshold S1 and the second threshold S2 may be early warning levels that control the automatic adjustment of the output voltage of the regulator 104. A third absolute threshold (Lim) may be an absolute threshold in which the system may stop operating properly if the power goes above this limit. In this case, the electronic device or a subsystem may be shut down or other undesirable measures taken. In one example, the thresholds may be current thresholds if current is being monitored, such as the first threshold S1 is 3.5 A, the second threshold S2 is 3 A, and the absolute threshold Lim may be 4 A. Other thresholds may also be employed, such as power or voltage thresholds. That is, the absolute threshold Lim is above the threshold S1, which is above the threshold S2. By providing the other thresholds S1 and S2, the Vout control logic 112 may adjust the output voltage Vout of the regulator 104 such that the threshold Lim may not be reached. This may avoid an undesirable shutdown of components of the electronic device.

When the monitored power meets the first threshold S1 (e.g., is equal to and/or above), the first comparator 206-1 outputs a signal, such as a “high” signal to the Vout control logic 112. In addition, when the monitored power meets the second threshold S2 (e.g., is equal to or below), the second comparator 206-2 outputs a high signal to the Vout control logic 112. Conversely, when the power goes below the first threshold or above the second threshold, the comparators 206-1 and 206-2, respectively, output a “low” signal to Vout control logic 112.

When threshold S1 is met, the Vout control logic 112 may send a signal to the regulator 104 to step the output voltage Vout down an increment. The increment may be preset and may be around 32 millivolt (mV)/6 microseconds (p). When the threshold S2 is met, then Vout control logic 112 may output a signal to the regulator 104 to increase the output voltage by an increment, such as by the same 32 mV/6 μs increment. Each time one of the thresholds is met, then Vout control logic 112 may signal the regulator 104 to adjust the output voltage by another increment. In one aspect, once the threshold is hit and goes above or below the threshold, the signal should be cleared before it can be met again. In other aspects, at every clock cycle, the power is checked, and if one of the thresholds is met, the signal is asserted again.

In accordance with aspects of the present disclosure, power may also be controlled during removal of a battery such as during a process of swapping and/or replacing a battery in an electronic device (e.g., battery swap).

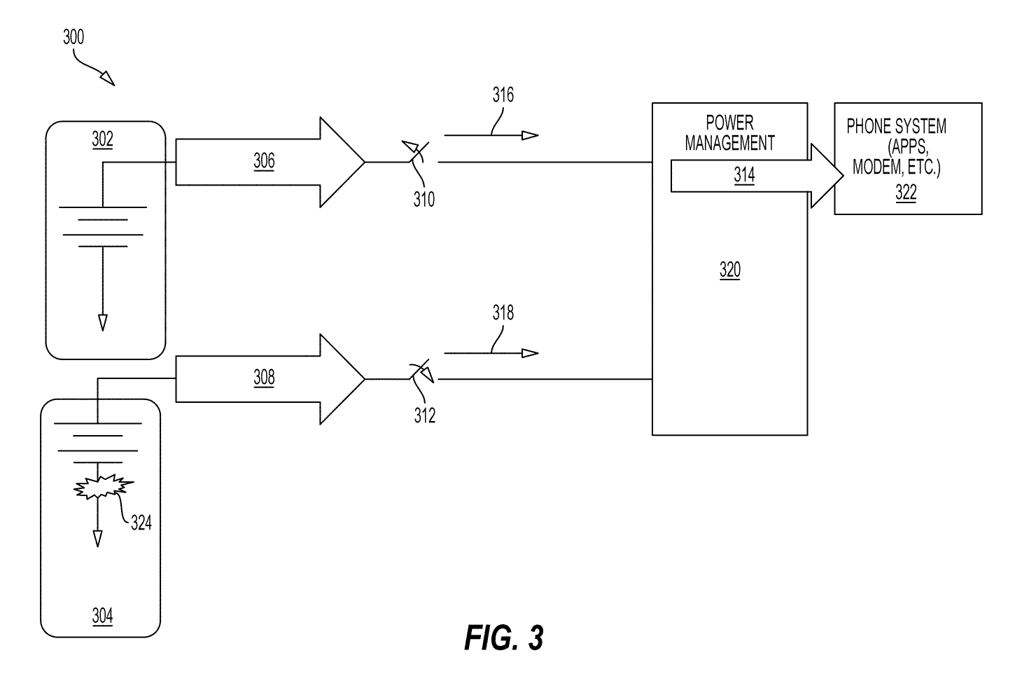

FIG. 3 illustrates an exemplary implementation for a dual battery system 300 (e.g., battery swap circuit) of a mobile device. The system 300 may include a first battery 302 and a second battery 304. The first battery 302 may generate a first current 306 along a first circuit path 316 to a power management circuit 320. The power management circuit 320 may be substantially similar to the above description in relation to FIGS. 1 and 2.

The power management circuit 320 receives the first current 306 to power an operational load 314 for a phone system 322. The phone system 322 may include software (e.g., applications), hardware such as a Wi-Fi subsystem, a cellular subsystem, a camera subsystem, a flash subsystem, and the like.

When a battery swap (e.g., hot swap) is performed, the first battery 302 may be removed while the mobile device is still operational. For example, upon removal of the first battery 302, a first switch 310 opens to disengage the first battery 302 from the system 300. Substantially simultaneously, a second switch 312 closes, thus engaging the second battery 304. The second battery 304 supplies a second current 308 along a second circuit path 318 to power the operational load 314. For example, the power supplied by the second battery 304 may be multiplexed (muxed) into the system 300.

In some instances, the operational load 314 may exceed a threshold current value of the second battery 304 and protection circuitry is toggled. Toggling of the protection circuitry may cause an undesirable disruption (e.g., loss of power, as shown by way of element 324) in the mobile device. As such, it is desirable to implement a dual battery system for a mobile device that allows for swapping of a primary battery without interrupting the functionality of the mobile device, which may include hot swapping of the primary battery.

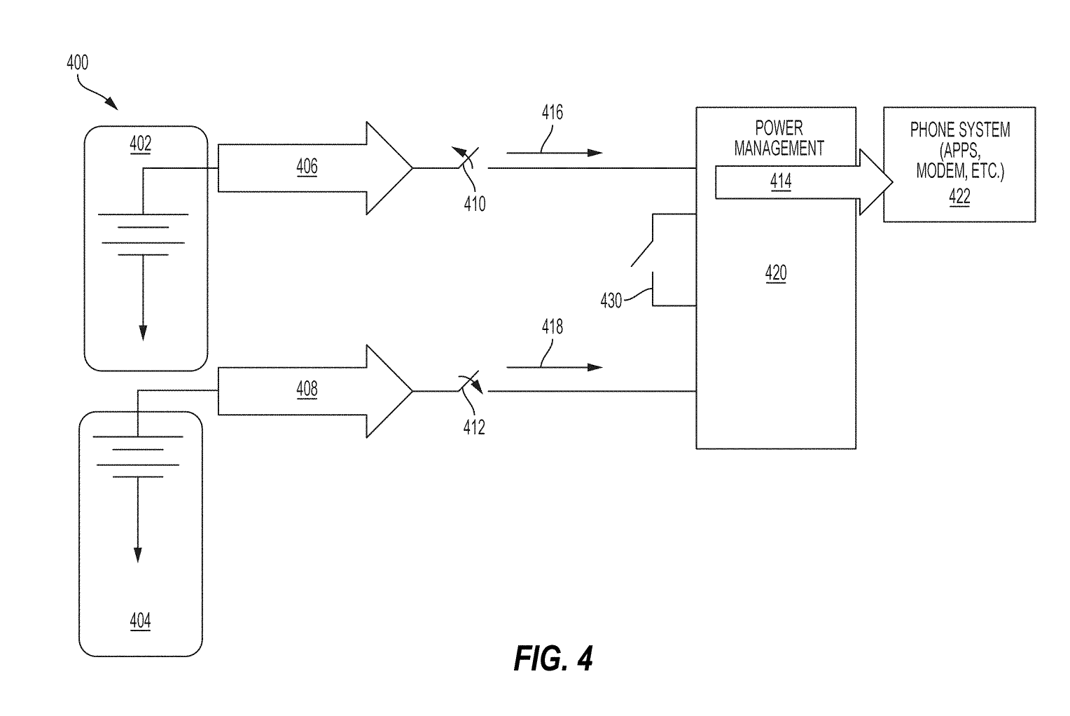

FIG. 4 illustrates an exemplary implementation for a dual battery system 400 with a hardware switch 430 for initiating battery current control. In accordance with aspects of the present disclosure, the system 400 addresses the shortcomings described above by reducing an operational load 414 prior to removal of a primary battery.

The system may include a first battery 402 (e.g., primary battery) and a second battery 404 (e.g., secondary battery). The first battery 402 may be the same size (e.g., capacity) or larger than the second battery 404. For example, the first battery 402 may have a rating of 3 Ah and a threshold limit of 10 A, and the second battery 404 may have a rating of 500 mAh and a threshold limit of 1 A. Of course, these values are exemplary only, and are non-limiting. In some aspects, the first battery 402 and the second battery 404 may be rechargeable cellular phone batteries, including, but not limited to lithium-ion, lithium polymer, or the like.

The first battery 402 may generate a first current 406 along a first circuit path 416. A power management circuit 420 may be coupled to the first battery 402 via the first circuit path 416. The power management circuit 420 may receive the first current 406 in order to power an operational load 414 for a phone system 422. The phone system 422 may be coupled to the power management circuit 420. The operational load 414 may vary between a high load and a low load depending on how much processing power is consumed by the phone system 422. The phone system 422 may include software (e.g., applications), hardware, and the like.

During a battery swap (e.g., hot swap) procedure, the first battery 402 (e.g., removable first battery) is removed. In accordance with an aspect, removal of the first battery 402 may include toggling a power switch 430 (e.g., power control switch). For example, the power switch 430 may toggle into an open position from a closed position when the first battery 402 is removed. Toggling of the power switch 430 in this manner causes the power management circuit 420 to reduce, throttle or otherwise modify the operational load 414 to a value less than or equal to a threshold value of the second battery 404. For example, the operational load 414 may be reduced from 2 A to 500 mA. As such, the second battery 404 is able to supply a second current 408 along a second path 418 to the power management circuit 420 to power the operational load 414 without exceeding a threshold value of the second battery 404. Subsequently, a third battery may replace the first battery 402 to resume normal operation of the mobile device. In some aspects, the third battery may be a new battery or the first battery 402. As described, a battery swap procedure may thus be completed without interruption to the operating system (e.g., high level operating system (HLOS), real-time operating system (RTOS), etc.) of the mobile device.

In accordance with an aspect of the present disclosure, the power switch 430 may be toggled or actuated by a button or a first battery casing. For example, a button may be engaged prior to or simultaneously with removal of the first battery 402. The button may be a push button, a soft button, or a hard button. In another example, the first battery 402 may include a casing (e.g., first battery casing), such that the casing is removed prior to removal of the first battery 402. Removal of the casing causes or triggers the power switch 430 to toggle open. For example, a detection circuit may detect actual removal of the first battery 402 through a battery ID pin and/or a battery thermistor.

In accordance with an aspect of the present disclosure, removal of the first battery 402 causes a first switch 410 (which may be referred to as a power path switch) to open from a closed position, in addition to toggling the power switch 430. For example, the power switch 430 may be toggled prior to the first switch 410. A second switch 412 may be configured to simultaneously close from an open position when the first switch 410 opens. Closing of the second switch 412 allows the current 408 from the second battery 404 to be delivered along the second path 418 to the power management circuit 420.

According to an aspect of the present disclosure, a detector may throttle the system. For example, a mitigating current may be used to facilitate switching of a battery. This may be implemented in a system in which a larger battery may be removed while a smaller battery remains in the system. The detector may include a hardware button, a touch sensor, or other means of detecting a potential removal of a battery.

Advantages of the system 400 include the ability to hot swap a primary battery without interrupting the services of a mobile device such as phone system 422 (e.g., without having to power down or restart the phone system 422). Additionally, in the undesirable event of a battery failure or accidental removal of the primary battery, the system 400 may continue operating via the operating system (e.g., HLOS) while the primary battery is replaced. In this way, information and data being communicated via the phone system may be preserved.

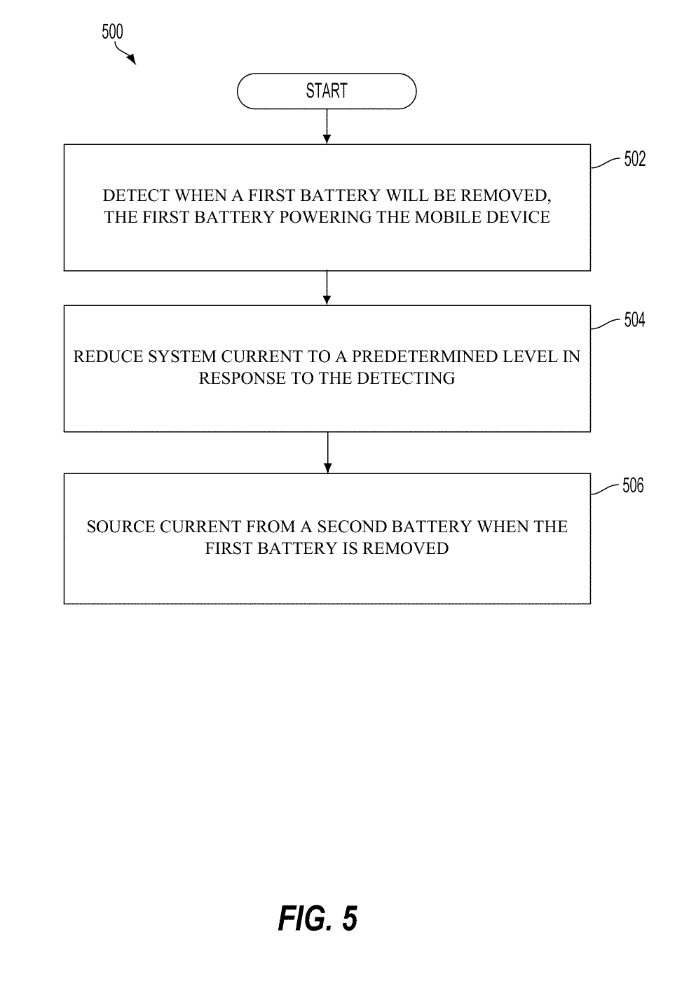

FIG. 5 depicts a flowchart of a method 500 of enabling a battery hot swap using hardware switching to initiate battery current mitigation, in accordance with aspects of the present disclosure. At block 502, the process detects when a first battery (e.g., a removable battery) will be removed. The first battery may power a mobile device. In some aspects, the process may detect an indication (e.g., button actuation) that the battery is to be removed. For example, as shown in FIG. 4, the power switch 430 may be toggled when there is an indication that the first battery 402 is or will be removed. Additionally, the first switch 410 may open once the first battery 402 is removed. In some aspects, the detecting may include detecting a broken connection associated with a first battery casing. For example, the detecting may occur upon removal of a predetermined portion of the casing (e.g., the back cover).

At block 504, the process reduces a system current to a predetermined level in response to the detecting. For example, as shown in FIG. 4, when the first battery 402 is removed, the first battery 402 no longer supplies power to the mobile device. In some aspects, the system current for a mobile device may be reduced by reducing the display brightness, reducing the maximum transmit power, reducing wireless throughput, disabling a torch mode and/or flash mode, operating the mobile device at a lower clock or frequency, removing one or more processor cores, throttling a video rate (e.g., in frames per second), throttling audio power (e.g., volume), removing or reducing an audio input stream, reducing a volume, reducing a resolution, disabling on-the-go, disabling a display port, or any combination thereof.

In accordance with an aspect of the present disclosure, reducing the system current may include keeping an operating system (e.g., a high level operating system (HLOS), a real-time operating system (RTOS), etc.) in a low power state. For example, extraneous unused functionality such as Bluetooth, GPS, wireless LAN, etc., may be disabled or shut off to keep the HLOS running in a low power state, but enough functionality is kept to run background functionality, such as a phone call, games, other mobile applications, etc., without interruption or crashing. Additionally, the low power state may allow for a minimum level of functionality, such that features may function with degraded performance while still working (e.g., display dims but remains on, application processor cores may be hot plugged and/or system clock speeds may be reduced but remain active, graphics core clock frequency may be reduced, emergency phone call is not interrupted, etc.) The predetermined level may be less than or equal to a current limit of a second battery. For example, as shown in FIG. 4, the power management circuit 420 reduces an operational load 414 to a predetermined level.

At block 506, the process sources current from a second battery when the first battery is removed. In some aspects, the first battery may be a primary battery and the second battery may be a secondary battery. Referring again to FIG. 4, the second switch 412 closes to connect the second battery 404 to the power management circuit 420. The second battery 404 may deliver a second current 408 along a second path 418 to power phone system 422. In accordance with an aspect, the first battery 402 and the second battery 404 may have different voltages. For example, the first battery 402 may have a higher voltage than the second battery 404.

According to the present disclosure, a state of an operating system (e.g., HLOS) is maintained throughout the battery swap. Additionally, a third battery may be installed, and current may be sourced from the third battery instead of the second battery. For example, the first battery 402 and the third battery have the same current, while the second battery 404 has a lower current than the first battery 402 and the third battery. The third battery may be the first battery or a new battery.

According to a further aspect of the present disclosure, a battery hot swap circuit is presented. The battery hot swap circuit includes means for detecting when a first battery will be removed. The means for detecting may, for example, include the power management circuit 420. The battery swap circuit also includes means for reducing a system current to a predetermined level. The means for reducing may, for example, include the power management circuit 420. The battery swap circuit further includes means for sourcing current from a second battery. The means for sourcing current may, for example, include the second battery 404, the second switch 412, the power switch 430, or the power management circuit 420.

In another aspect, the various operations of methods described above may be performed by any suitable means capable of performing the corresponding functions. For example, the means for detecting, the means for reducing system current, and the means for sourcing current may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

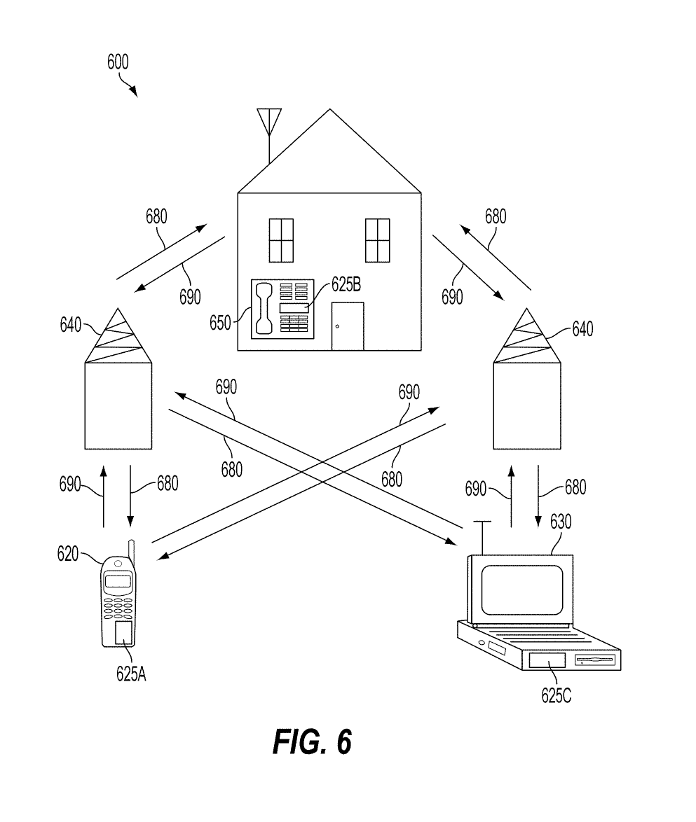

FIG. 6 is a block diagram showing an exemplary wireless communication system 600 in which an aspect of the present disclosure may be advantageously employed. For purposes of illustration, FIG. 6 shows three remote units 620, 630, and 650 and two base stations 640. It will be recognized that wireless communication systems may have many more remote units and base stations. Remote units 620, 630, and 650 include IC devices 625A, 625C, and 625B that include the disclosed battery hot swap circuit. FIG. 6 shows forward link signals 680 from the base station 640 to the remote units 620, 630, and 650 and reverse link signals 690 from the remote units 620, 630, and 650 to base station 640.

In FIG. 6, remote unit 620 is shown as a mobile telephone, remote unit 630 is shown as a portable computer, and remote unit 650 is shown as a fixed location remote unit in a wireless local loop system. For example, a remote units may be a mobile phone, a hand-held personal communication systems (PCS) unit, a portable data unit such as a personal digital assistant (PDA), a GPS enabled device, a navigation device, a set top box, a music player, a video player, an entertainment unit, a fixed location data unit such as a meter reading equipment, or other communications device that stores or retrieve data or computer instructions, or combinations thereof. Although FIG. 6 illustrates remote units according to the aspects of the present disclosure, the disclosure is not limited to these exemplary illustrated units. Aspects of the present disclosure may be suitably employed in many devices, which include the disclosed battery hot swap circuit.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general-purpose or special-purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD) and Blu-ray disc where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “a step for.”

1. A method of enabling a battery hot swap in a mobile device, comprising:
anticipating when a removable first battery will be removed by monitoring a hardware switch, the removable first battery powering the mobile device;
reducing a system current to a predetermined level in response to the detecting; and
sourcing current from a second battery in response to anticipating the removable first battery will be removed.

2. The method of claim 1, in which the predetermined level is less than or equal to a current limit of the second battery.

3. The method of claim 1, in which the anticipating comprises detecting a broken connection associated with a first battery casing.

4. The method of claim 1, further comprising maintaining a state of a high level operating system (HLOS) throughout the battery hot swap.

5. The method of claim 1, in which the removable first battery comprises a primary battery and the second battery comprises a secondary battery.

6. The method of claim 1, in which the reducing comprises:
reducing display brightness, reducing maximum transmit power, reducing wireless throughput, disabling a torch mode and/or a flash mode, reducing a system clock or frequency, removing processor cores, throttling a video rate, throttling audio power, removing or reducing an audio input stream, reducing a volume, reducing a resolution, disabling on-the-go, disabling a display port, or any combination thereof.

7. The method of claim 1, further comprising:
installing a third battery; and
sourcing current from the third battery instead of the second battery.

8. The method of claim 7, in which the third battery is the removable first battery or a new battery.

9. The method of claim 1, further comprising enabling the battery hot swap in at least one of a music player, a video player, an entertainment unit, a navigation device, a communications device, a personal digital assistant (PDA), a fixed location data unit, a mobile phone, and a portable computer.

10. A battery hot swap circuit, comprising:
a removable first battery configured to power a mobile device;
a power control switch coupled to the removable first battery, the power control switch configured to reduce a system current to a predetermined level in response to an indication that the removable first battery will be removed;
a power management circuit coupled to the power control switch; and
a second battery coupled to the power control switch configured to power the mobile device at the predetermined level the removable first battery is removed.

11. The battery hot swap circuit of claim 10, further comprising a phone system coupled to the power management circuit.

12. The battery hot swap circuit of claim 10, further comprising:
a first switch coupled to the removable first battery and the power control switch; and
a second switch coupled to the second battery and the power control switch.

13. The battery hot swap circuit of claim 10, in which the removable first battery is configured to generate a first current and the second battery is configured to generate a second current.

14. The battery hot swap circuit of claim 10, in which the predetermined level is less than or equal to a current limit of the second battery.

15. The battery hot swap circuit of claim 10, in which the removable first battery comprises a first battery casing.

16. The battery hot swap circuit of claim 10, integrated into at least one of a music player, a video player, an entertainment unit, a navigation device, a communications device, a personal digital assistant (PDA), a fixed location data unit, a mobile phone, and a portable computer.

17. A battery hot swap circuit, comprising:
means for anticipating when a removable first battery will be removed by monitoring a hardware switch, the removable first battery powering a mobile device;
means for reducing a system current to a predetermined level in response to a signal from the means for detecting; and
means for sourcing current from a second battery in response to anticipating the removable first battery will be removed.

18. The battery hot swap circuit of claim 17, in which the predetermined level is less than or equal to a current limit of the second battery.

19. The battery hot swap circuit of claim 17, in which the removable first battery comprises a primary battery and the second battery comprises a secondary battery.

20. The battery hot swap circuit of claim 17, in which the means for anticipating comprises means for detecting a broken connection associated with a first battery casing.

21. The battery hot swap circuit of claim 17, further comprising means for maintaining a state of a high level operating system (HLOS) throughout a battery hot swap.

22. The battery hot swap circuit of claim 17, in which the means for reducing comprises means for:
reducing display brightness, reducing maximum transmit power, reducing wireless throughput, disabling a torch mode and/or a flash mode, reducing a system clock or frequency, removing processor cores, throttling a video rate, throttling audio power, removing or reducing an audio input stream, reducing a volume, reducing a resolution, disabling on-the-go, disabling a display port, or any combination thereof.

23. The battery hot swap circuit of claim 17, further comprising:
means for sourcing current from a third battery instead of the second battery.

24. The battery hot swap circuit of claim 23, in which the third battery is the removable first battery or a new battery.

25. The battery hot swap circuit of claim 17, further comprising enabling a battery hot swap in at least one of a music player, a video player, an entertainment unit, a navigation device, a communications device, a personal digital assistant (PDA), a fixed location data unit, a mobile phone, and a portable computer.
